(19) United States
(12) Patent Application Publication
(10) Pub. No.: US 2016/0139284 A1
(43) Pub. Date: May 19, 2016

(54) MARINE SEISMIC PATTERNS FOR COORDINATED TURNING OF TOWING VESSELS AND METHODS THEREFOR

(71) Applicant: CGG SERVICES SA, Massy (FR)

(72) Inventor: Michael MEECH, Plymouth (GB)

(21) Appl. No.: 14/893,719

(22) PCT Filed: Jun. 10, 2014
(86) PCT No.: PCT/EP2014/062054

§ 371 Date: Nov. 24, 2015

Related U.S. Application Data
(60) Provisional application No. 61/834,073, filed on Jun. 12, 2013.

(51) Int. Cl. G01V 1/38; G05D 1/02

(52) U.S. Cl. CPC G01V 1/3808; G05D 1/0206

(57) ABSTRACT

Methods for performing marine seismic surveys are disclosed. Survey lines can be traversed and the survey vessels can be turned by following determined turn paths which are based on a number of factors including, whether they are source or streamer vessels, the length of towed equipment, a turn radius, and/or other factors. Such methods can be applied using various seismic survey vessel configurations, e.g., a long-offset, diagonally-staggered configuration.

### PRIORITY INFORMATION

The present application claims priority under 35 U.S.C. §119(e) to U.S. Provisional Patent Application Ser. No. 61/834,073 filed Jun. 12, 2013, the entire contents of which are expressly incorporated herein by reference.

### TECHNICAL FIELD

The present embodiments relate generally to marine seismic exploration systems, devices and methods, and more specifically to systems and methods for towing sources and streamers associated with such marine seismic systems, devices and methods.

### BACKGROUND

Seismic waves generated artificially for the imaging of geological layers have been used for more than 50 years. In a marine setting, the most widely used waves are by far reflected waves and more precisely reflected compressional waves, recorded by hydrophones and/or accelerometers. In other settings (e.g. land and ocean bottom surveys), shear wave energy can also be of interest. During seismic prospection operations, vibrator equipment (also known as a “source”) generates a seismic signal that propagates in particular in the form of a wave that is reflected on interfaces of geological layers. These waves are received by geophones, or receivers, which convert the displacement of the ground resulting from the propagation of the waves into an electrical signal recorded by means of recording equipment. Analysis of the arrival times and amplitudes of these waves makes it possible to construct a representation of the geological layers on which the waves are reflected.

A widely used technique for searching for oil or gas, therefore, is the seismic exploration of subsurface geophysical structures. Reflection seismology is a method of geophysical exploration to determine the properties of a portion of a subsurface layer in the earth, which information is especially helpful in the oil and gas industry. Marine-based seismic data acquisition and processing techniques are used to generate a profile (image) of a geophysical structure (subsurface) of the strata underlying the seafloor. This profile does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process.

The seismic exploration process consists of generating seismic waves (i.e., sound waves) directed toward the subsurface area, gathering data on reflections of the generated seismic waves at interfaces between layers of the subsurface, and analyzing the data to generate a profile (image) of the geophysical structure, i.e., the layers of the investigated subsurface. This type of seismic exploration can be used both on the subsurface of land areas and for exploring the subsurface of the ocean floor.

Marine reflection seismology is based on the use of a controlled source that sends energy waves into the earth, by first generating the energy waves in or on the ocean. By measuring the time it takes for the reflections to come back to one or more receivers (usually very many, perhaps in the order of several dozen, or even hundreds), it is possible to estimate the depth and/or composition of the features causing such reflections. These features may be associated with subterranean hydrocarbon deposits.

One of the ways to perform marine seismic surveys is to tow an array of acoustic sources and receivers on streamers to generate source signals and receive corresponding reflections. An example of such a marine seismic survey system is provided in FIG. 1(a). For a seismic gathering process, as shown in FIG. 1(a), a data acquisition system 10 includes a ship 2 towing plural streamers 6 that may extend over kilometers behind ship 2. Each of the streamers 6 can include one or more birds 13 that maintains streamer 6 in a known fixed position relative to other streamers 6, and the birds 13 are capable of moving streamer 6 as desired according to bi-directional communications birds 13 can receive from ship 2. One or more source arrays 4a,b may be also towed by ship 2 or another ship for generating seismic waves. Source arrays 4a,b can be placed either in front of or behind receivers 14 (shown below in FIG. 2, and also located on streamers 6), or both behind and in front of receivers 14. The seismic waves generated by source arrays 4a,b propagate downward, reflect off of, and penetrate the seafloor, wherein the refracted waves eventually are reflected by one or more reflecting structures (not shown in FIG. 1) back to the surface (see FIG. 2, discussed below). The reflected seismic waves propagate upwardly and are detected by receivers 14 provided on streamers 6. This process is generally referred to as “shooting” a particular seafloor area, and the seafloor area can be referred to as a “cell”, or geographical area of interest (GAI).

Typically, a marine seismic survey will be conducted over a predetermined seafloor area which requires a number of passes by the vessel 2 to fully shoot the entire area with acoustic waves and record the corresponding reflections. For example, as shown in FIG. 1(b), the vessel 2 (represented here by arrows) can tow its arrays of streamers and sources in within an area bounded by the rectangle 1000 in a predetermined pattern to fully illuminate the underlying seafloor. The vessel alternates its direction at the end of each pass by turning around, as illustrated by the rounded parts of the path 1020 shown at the end of each pass, to criss-cross the rectangle 100 during the survey. The turns 1020 can be performed in such a way that the streamers and sources towed by the vessel 2 are in the same orientation for each pass as the vessel enters the rectangular region of interest. It will be appreciated by those skilled in the art that the region of interest need not be rectangular, and that the marine seismic system 10 of FIG. 1 is purely exemplary.

The pattern illustrated in FIG. 1(b) is relatively simple, and careful handling of the vessel 2 in conjunction with the assistance of the birds 13 can be sufficient to maintain the proper spacing of the streamers 6, and avoid tangling thereof. However more recently seismic surveying systems have been developed which use multiple towing vessels in various configurations. A particular configuration of interest in this specification is the so-called long offset, diagonally-staggered configuration, wherein the multiple towing vessels have a relatively great in-line distance relative to one another (although the present invention is not limited thereto).

Accordingly, it would be desirable to provide methods, systems and devices to address how to architect patterns for sweeping the geographical areas of interest with multiple towing vessels and, in particular, how to efficiently turn marine seismic systems having long-offset configurations while performing a seismic survey.

### SUMMARY

An aspect of the embodiments is to substantially solve at least one or more of the problems and/or disadvantages discussed above, and to provide at least one or more of the advantages described below.

It is therefore a general aspect of the embodiments to provide a technique for turning fleets of seismic surveying vessels, e.g., fleets in a long-offset, diagonally-staggered configuration, in a manner that will obviate or minimize problems of the type previously described and which will balance turn speed and safety.

According to a first aspect of the embodiments, a method for turning a fleet of seismic surveying vessels having a long-offset, diagonally-staggered configuration and which are performing a seismic survey in a survey area located within a geographical area from a first survey line to a next survey line includes the steps of: beginning to turn each seismic surveying vessel in the fleet away from the first survey line at a predetermined turn start point, wherein the predetermined turn start point for a respective vessel is disposed at a point in the geographical area such that an inline mid-point between the respective vessel's source and a most distant receiver group in the fleet is no longer within the survey area, ending the turn of each seismic surveying vessel in the fleet into the next survey line at a predetermined turn end point, wherein the predetermined ending point is disposed at a point in the geographical area such that for all source-only seismic surveying vessels in the fleet, these source-only vessels are positioned on a heading of the next survey line before their respective source contributes to any inline mid-points inside the survey area, and such that for seismic surveying vessel towing streamers substantially any residual shape from the turn is no longer held in the vessel's streamer cables, and navigating the seismic survey vessels along turn paths, wherein a turn path between the predetermined turn start point and predetermined turn end point for each seismic surveying vessel in the fleet is a function of the predetermined turn start point, the predetermined turn end point, a length of equipment towed by that vessel, a total distance to be traversed during the turn, and a minimum separation distance between vessels.

According to a second aspect of the embodiments, a method for performing seismic surveys includes the steps of: performing a seismic survey using a plurality of seismic survey vessels having deployed in a long-offset, diagonally-staggered configuration and which are performing a seismic survey in a survey area located within a geographical area from a first survey line to a next survey line, and turning the seismic survey vessels along turn paths, wherein a turn path between the a predetermined turn start point and a predetermined turn end point for each seismic surveying vessel in the fleet is a function of the predetermined turn start point, the predetermined turn end point, a length of equipment towed by that vessel, a total distance to be traversed during the turn, and a minimum separation distance between vessels.

According to a third aspect of the embodiments, a method for performing seismic surveys includes the steps of acquiring seismic data using a plurality of seismic survey vessels traversing a survey line; and turning the plurality of seismic survey vessels, from one survey line to the next, along turn paths, wherein a turn path between a start turn start point and a turn end point for each seismic survey vessel is a function of the turn start point, the turn end point, a length of equipment towed by that vessel, a total distance to be traversed during the turn, and a minimum separation distance between vessels.

### BRIEF DESCRIPTION OF THE DRAWINGS

The above and other aspects of the embodiments will become apparent and more readily appreciated from the following description of the embodiments with reference to the following figures, wherein like reference numerals refer to like parts throughout the various figures unless otherwise specified, and wherein:

FIG. 1(a) illustrates a top view of a marine seismic exploration system for use in an underwater seismic gathering process;

FIG. 1(b) depicts turning of a seismic survey vessel to shoot a survey area;

FIG. 2 illustrates a side view of the marine seismic exploration system of FIG. 1 and pictorially represents transmitted, reflected, refracted and multiples seismic waves;

FIG. 3 illustrates a general method for seismic exploration;

FIG. 4 depicts an example of a seismic survey fleet with different offset characteristics;

FIG. 5(a) shows a long-offset, diagonally-staggered seismic survey fleet according to an embodiment;

FIG. 5(b) shows an inline midpoint associated with the seismic survey fleet of FIG. 5(a);

FIG. 6 is a flow diagram illustrating a method for turning a seismic survey fleet according to an embodiment;

FIGS. 7(a)-7(j) depict various turn paths or patterns for seismic surveying vessels and fleets according to embodiments;

FIG. 8 is a flow diagram illustrating a method for performing a seismic survey according to an embodiment; and

FIG. 9 is a flow diagram illustrating a method for acquiring seismic data according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. It will be apparent to one skilled in the art, however, that at least some embodiments may be practiced without one or more of specific details described herein. In other instances, well-known components or methods are not described in details or are presented in simple block diagram format in order to avoid unnecessarily obscuring the embodiments. The scope of the embodiments is therefore defined by the appended claims.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

Prior to discussing techniques for towing marine surveying equipment according to the embodiments, a brief discussion of marine seismic surveying equipment and acquisition methods is provided for context.

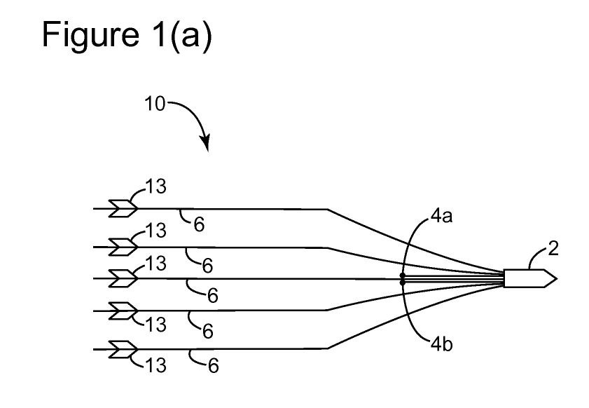

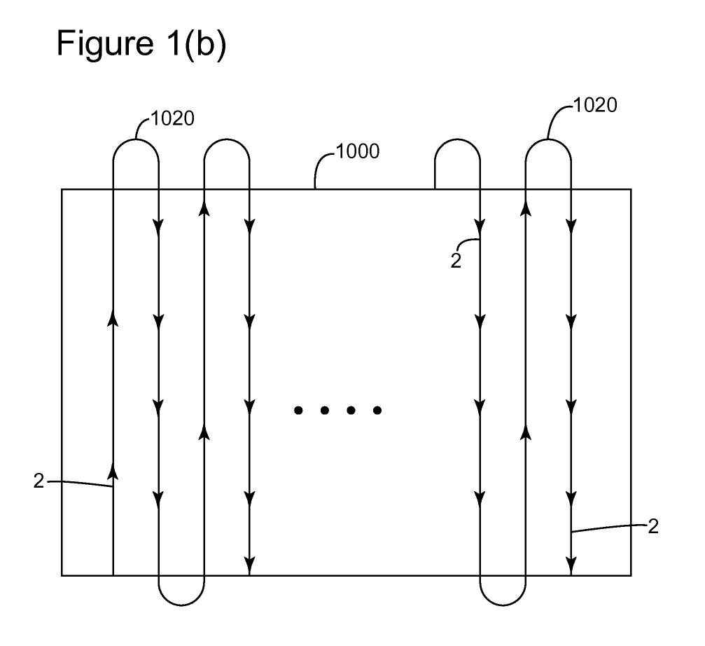

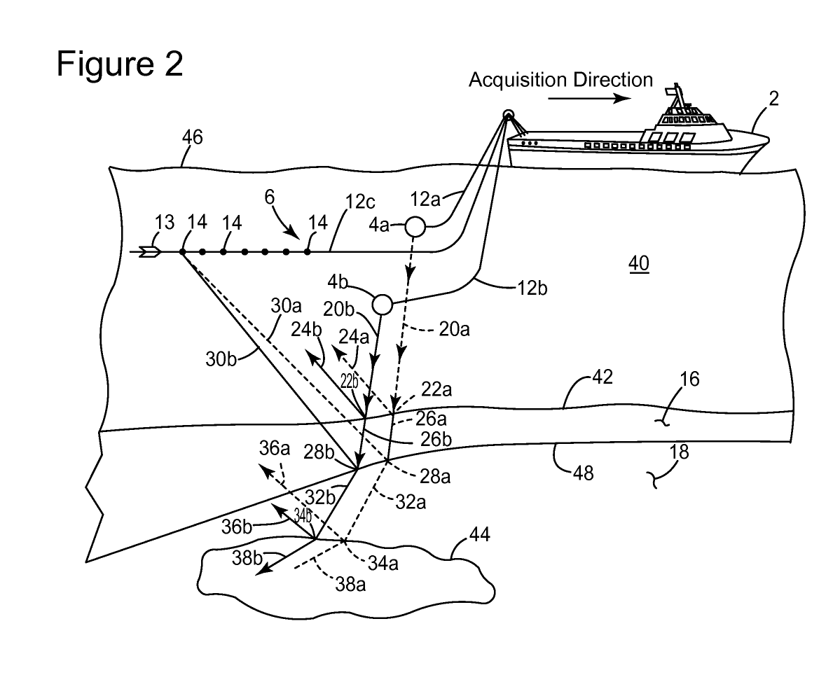

FIG. 2 illustrates a side view of the data acquisition system 10 of FIG. 1. Ship 2, located on ocean surface 46 of ocean water 40, tows one or more streamers 6, that is comprised of cables 12, and a plurality of receivers 14. Shown in FIG. 2 are two source streamers, which include sources 4a,b attached to respective cables 12a,b. Each source 4a,b is capable of transmitting a respective sound wave, or transmitted signal 20a,b. For the sake of simplifying the drawings, but while not detracting at all from an understanding of the principles involved, only a first transmitted signal 20a will be discussed in detail (even though some or all of source 4 can be simultaneously (or not) transmitting similar transmitted signals 20). First transmitted signal 20a travels through ocean 40 and arrives at first refraction/reflection point 22a. First reflected signal 24a from first transmitted signal 20a travels upward from ocean floor 42, back to receivers 14. As those of skill in the art can appreciate, whenever a signal—optical or acoustical—travels through a first medium with a first index of refraction n1 and then into a second, different medium, with a second index of refraction n2, a portion of the transmitted signal is reflected at an angle equal to the incident angle (according to the well-known Snell's law), and a second portion of the transmitted signal can be refracted at a different angle (again according to Snell's law).

Thus, as shown in FIG. 2, first transmitted signal 20a generates first reflected signal 24a, and first refracted signal 26a. First refracted signal 26a travels through sediment layer 16 (which can be generically referred to as first subsurface layer 16) beneath ocean floor 42, and can now be considered to be a “new” transmitted signal, such that when it encounters a second medium at second refraction/reflection point 28a, a second set of refracted and reflected signals 32a and 30a, are subsequently generated. Further, as shown in FIG. 2, there happens to be a significant hydrocarbon deposit 44 within a third medium, or solid earth/rock layer 18 (which can be generically referred to as second subsurface layer 18). Consequently, refracted and reflected signals are generated by the hydrocarbon deposit, and it is at least one purpose of data acquisition system 10 to generate data that can be used to discover such hydrocarbon deposits 44. As further seen in FIG. 2, second refracted signal 32a encounters hydrocarbon deposit 44, at third refraction/reflection point 34a, generating third refracted signal 38a, and third reflected signal 36a. Further, second transmitted signal 20b generates first reflected and refracted signals (from second transmitted signal) 24b, and 26b, respectively, at first reflection/refracting point 22b. Second refracted signal 26b encounters solid earth/rock layer 18 at second reflection/refraction point 28b, thereby generating second reflected signal 30b, and second refracted signal 32b. Second refracted signal 32b travels through second layer 18 and encounters hydrocarbon deposit 44 and third reflection/refraction point 34b, and generates third reflected signal 36b and third refracted signal 38b.

As those of skill in the art can appreciate, while it appears that this process can continue ad infinitum and such may be technically true and possible, but with each reflection/refraction, only a certain percentage of the energy from the impinging signal is reflected and refracted, and so the strength of the signal diminishes quickly, and can, in fact, after only a few encounters with such interfaces, diminish to the point that the sensitivity of receivers 14 is not large enough to distinguish the signals over other noise in the system. Nonetheless, it is an important part of seismic signal processing to discern different refracted/reflected signals from the noise to the greatest extent possible.

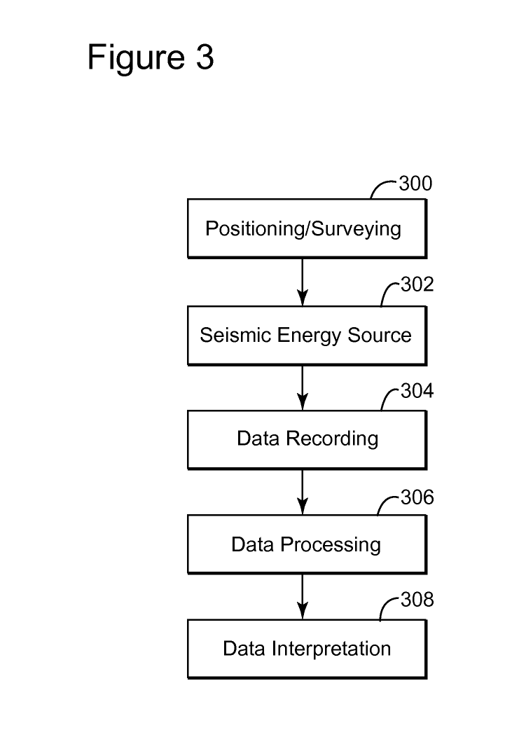

As generally discussed above, the main purpose of seismic exploration is to render the most accurate possible graphic representation of specific portions of the Earth's subsurface geologic structure (also referred to as a GAI). The images produced allow exploration companies to accurately and cost-effectively evaluate a promising target (prospect) for its oil and gas yielding potential (i.e., hydrocarbon deposits 44). FIG. 3 illustrates a general method for seismic exploration. In FIG. 3, there are five main steps, although one could express seismic surveying in a number of different ways, however a detailed discussion of any one of the process steps in FIG. 3 would exceed the scope of this document, but a general overview of the process should aid in understanding where the different aspects of the embodiments described below can aid in the overall process. Step 300 involves positioning and surveying of the potential site for seismic exploration. In step 302, seismic energy source waves are generated to shoot the area of interest. In step 304, data recording occurs. In a first part of this step, receivers 14, 64 receive and most often digitize the data, and in a second part of the step 506, the data is transferred to a recording station. In step 306, data processing occurs. Data processing generally involves enormous amounts of computer processing resources, including the storage of vast amounts of data, multiple processors or computers running in parallel. Finally, in step 308, data interpretation occurs and results can be displayed, sometimes in two-dimensional form, more often now in three dimensional form. Four dimensional data presentations (a 3D plot or graph, over time (the fourth dimension)) are also possible, when needed to track the effects of other processes, for example.

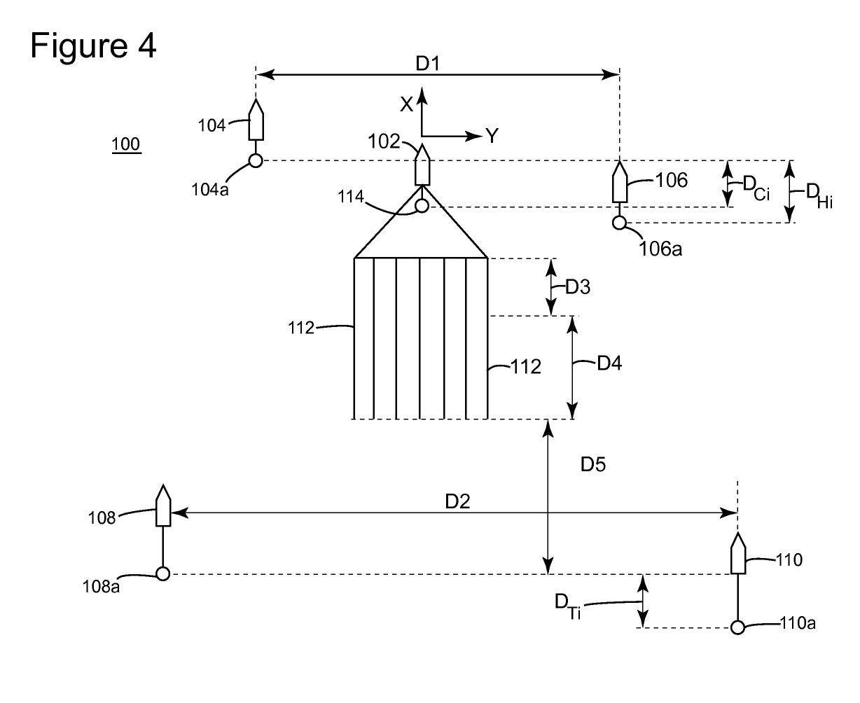

As mentioned earlier, the towed arrays including the sources and streamers with (or without) birds in a marine seismic system may be towed by a single vessel 2 as shown in FIG. 1(a), or may instead be towed by multiple vessels. One purely illustrative example of a long offset configuration of streamer and source vessels is illustrated in FIG. 4. Therein, a seismic acquisition system 100 is illustrated that includes a streamer vessel 102 and four source vessels 104, 106, 108 and 110. The streamer vessel 102 tows plural streamers 112 and, optionally, a source array 114. The source vessels tow corresponding source arrays 104a, 106a, 108a, and 110a. The source arrays may include one or more individual sources. An individual source may be, for example, an air gun. The streamers 112 are substantially parallel in this embodiment. However, as described in more detail below, the streamers 112 may be distributed in a dovetail-like shape. In one application, the streamers 112 are fanned in a horizontal plane (substantially parallel to the water surface) so that they make an angle with each other. To achieve this arrangement, birds may be located on each streamer 112, for maintaining the streamers at the desired positions. The birds are devices capable of maintaining a vertical and/or horizontal position in water.

To establish some more context for the offsets involved in such configurations, it is noted that the X axis in FIG. 4 corresponds to the traveling direction of the vessels, also known in the art as the inline, and the Y axis, which is perpendicular to X axis, is known in the art as the cross-line. With this convention, a cross-line distance D1 between sources 104a and 106a (front sources) may be approximately 1200 m while a cross-line distance D2 between sources 108a and 110a (tail sources) may be approximately 2400 m. A central source 114 may be placed at half distance between the front sources. These numbers are exemplary and not intended to limit the embodiments described below.

Another characteristic of such configurations is the inline distance between the sources and streamers. Considering the front sources 104a and 106a, it is noted that there is an inline displacement DHI between them. The central source 114 may also be displaced inline (e.g., DCI) relative to one of the front sources. A similar inline displacement DTI may be implemented for the tail sources 108a and 110a. The values for these inline displacements vary from survey to survey, depending on various factors such as, for example, length of streamers, number of streamers, depth of sea bottom, etc.

The streamers 112 may be towed to be substantially parallel or slanted to the water surface. As shown in FIG. 4, the streamers may have a length D3+D4 and an offset between an end of the streamer and the tail source 108a is D5. In one application, the streamers may have a curved profile, as described below (e.g., Broadseis configuration originated by CGG, France). Supposing that the streamer 112 shown in FIG. 4 has a length of, for example, 10 km, the curved portion may have a length D3=2 km and the flat portion may have a length D4=8 km. For these specific values, an offset of the tail source 108a relative to an end of the streamer (along the X axis) is about D5=8 km, i.e., substantially equal to the flat portion of the streamer. This is considered a large offset in the industry. However, for the purposes of the present specification, the term “long offset” is defined to mean one of: at least 300 m, at least 1 km or at least 2 km in the inline direction.

While performing a seismic survey, the five sources depicted in FIG. 4 may be fired using various schemes. One scheme is to shoot the sources sequentially, for example, at 37.5 m intervals (i.e., shoot a first front source, wait for the first front source to travel 37.5 m along the X axis, and then shoot the central source, and so on). The value of 37.5 m is exemplary and is based on the traveling speed of the streamer vessel. In this way, the sources are fired when they have the same inline position during a firing sequence. A firing sequence includes the sequential firing of each source once. Another scheme is to shoot the sources almost instantaneously, with random time delays. Still another scheme is to shoot the sources at the same times.

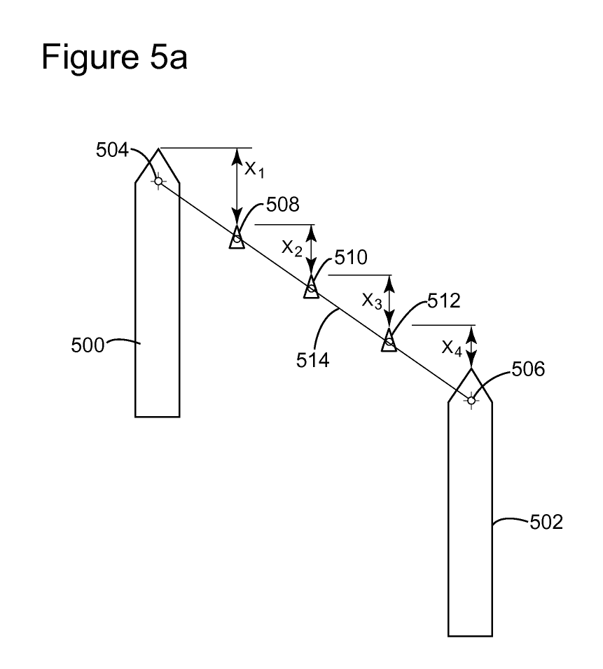

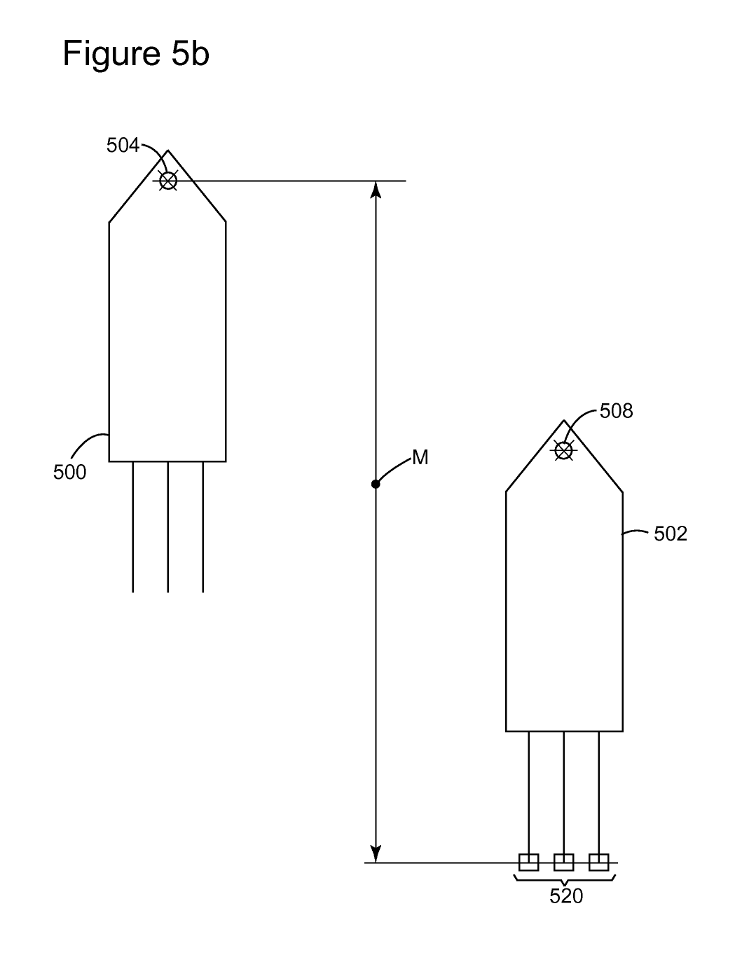

One type of long offset configuration has been discussed above with respect to FIG. 4. Many variations of such configurations can be envisioned. For example, another type of long offset configuration of particular interest is the so-called long offset, diagonally staggered configuration, an example of which is illustrated in FIG. 5(a). Therein, the system includes two streamer vessels 500 and 502, which have respective sources 504 and 506 and each of which tow an array of streamers (not shown) having acoustic receivers and birds disposed thereon. Additionally, the system includes three source vessels 508, 510 and 512, each of which tow one or more sources which can be used as described above to shoot the ocean floor during each pass of the system over the target area. For example, the outermost streamer vessels 500 and 502 in the system can, for example, each be towing an 8500 m streamer cable astern, while the source vessels 508, 510 and 512 can, for example, each be towing four source arrays having a total length of between 100 m and 200 m astern. Those skilled in the art will appreciate that these values are purely illustrative and that other lengths may be employed.

The long offset characteristic of the configuration of the seismic surveying system illustrated in FIG. 5(a) can be understood by considering that the inline offset distance between vessels, i.e., X1-X4 as shown in FIG. 5(a), is at least 300 m, at least 1 km or at least 2 km as mentioned previously. In one example, X1=X2=X3=X4=approximately 2100 m. Additionally, the vessels 500, 502, 508, 510 and 512 will be separated by a crossline spacing Y1=Y=Y2=Y3=Y4 (not specifically shown) which can, for example, be approximately 1200 m. In this configuration, a hypothetical diagonal line 514 can be drawn between the similar front portions of each of these vessels 500, 502, 508, 510 and 512 to indicate the diagonally staggered characteristic of the configuration. Note that although FIG. 5(a) depicts each of the vessels as being disposed neatly on the diagonal line 514, such a characteristic is not required for towing vessels to be arranged in a diagonally staggered configuration. Instead, the vessels can be substantially diagonally aligned, with one or more of the vessels being off of the diagonal line.

Indeed, in practice it is more important for such configurations that the center of energy of each of the source (gun) arrays on each vessel be substantially aligned along the diagonal line 514. This means that each vessel could deploy their guns to different lengths (e.g., a streamer-towing vessel might be 300-500 m inline offset, with a source-only vessel being 50-150 m inline offset) which means that the vessels themselves will be largely, but not exactly, diagonally aligned. Instead, the energy center of each of their sources will be substantially diagonally aligned. All such positioning variations are intended to be included in the phrase “diagonally staggered configuration”, “diagonally staggered pattern” or the like, as that phrase is used in the present specification.

It will be appreciated by those skilled in the art that when seismic system configurations like those described above with respect to FIGS. 4 and 5(a) turn at the end of each pass over the geographical area of interest, the pattern which is followed in performing the turn is necessarily more complex than the turn 1020 illustrated in FIG. 1(b) for a seismic system having a single vessel. In particular, the relative positions of the vessels and different lengths of the towed arrays make it significantly more challenging to determine an appropriate turn pattern, which is the subject of the embodiments described below.

According to these embodiments, it is desirable is to change the direction of a long-offset, diagonally-staggered seismic vessel configuration by 180 degrees. Examples will be provided for the fleet of five vessels sailing the same course in a diagonally-staggered pattern as described in FIG. 5(a), but the present invention is not limited thereto. The general considerations used in establishing turn patterns according to these embodiments include: (a) minimizing the risk of collision with another vessel, or entanglement with any piece of towed equipment, and (b) minimizing the amount of time spent turning the vessels while still respecting point (a). Regarding this latter point, it will be appreciate that turn time is also important as the more quickly the vessels can be properly turned and started on the next pass, the more quickly the entire survey can be performed, resulting in significant cost savings. In this regard, as described in more detail below, according to one embodiment, a predetermined start turn point can be determined based on an inline mid-point distance between a vessel's source and the farthest receiver group in the fleet. This is shown in FIG. 5(b) wherein the mid-point distance between source 504 and the furthest receivers 520 which are located toward the end of vessel 502's streamers is shown with mid-point M.

To derive turning patterns which satisfy criteria (a) and (b), embodiments first calculate the point when each of the vessels 500, 502, 508, 510 and 512 no longer contributes to production within the survey perimeter on its current survey line. This represents the earliest point at which a turn pattern for each vessel could begin. Next, a point is calculated for each vessel to complete the turn and be sailing the correct course for the next survey line. Third, embodiments find an acceptable route for all vessels between these two points for each vessel that also satisfies the two criteria (a) and (b) described above.

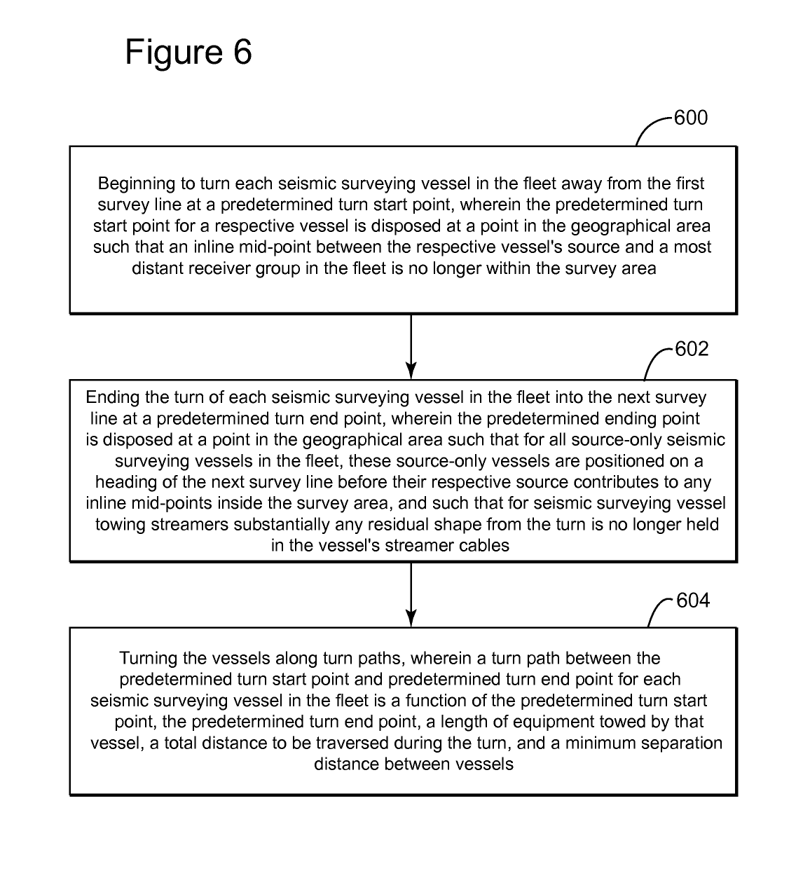

To provide some additional detail regarding one technique for performing these three steps, consider the following discussion as also illustrated by the flow diagram of FIG. 6. At step 600, a predetermined start turn point is calculated. More specifically, as briefly stated in step 600, and for each vessel in the fleet, the vessel may begin its divergence from the rest of the fleet at a predetermined start turn point, e.g., taking the example of vessel 500 in FIG. 5(b) when the inline mid-point M between its own source 504 and the farthest receivers 520 on streamers towed by other vessels such as vessel 508 in the fleet is no longer within the survey boundary (i.e., the full-fold area). This is the earliest that a vessel such as vessel 500 can deviate from the line azimuth on the survey grid, but the vessel may also continue in the survey direction after this point if there is no benefit to be had from turning at the earliest possible point or moment. When the layout of the vessels is known, this position can be calculated in advance.

Next, at step 602, a predetermined end turn point is selected or calculated as follows. On approach to the next survey line, the leading vessel in the fleet should be heading on the new line azimuth with sufficient distance to allow its towed equipment to no longer be shaped as a result of the turn. That is, the towed equipment (streamers and/or sources) should be disposed in the predetermined configuration which is to be maintained for transmitting and receiving acoustic waves as the vessel traverses the survey area. For example, for all source-only vessels in the fleet (such as vessels 508, 510 and 512), these vessels should be sailing on the survey line heading before their source contributes to any inline mid-points inside the survey boundary (i.e., full-fold area). For the vessels in the fleet which have a source and are towing streamers (such as vessels 500 and 502), this criteria means that the predetermined end turn point ensures that both that vessel's source is in the line heading before it contributes to any inline mid-points in the survey area, and also that any residual shape from the turn is no longer held in the vessel's streamer cables. The minimum distances for each vessel's source contribution can be calculated in advance. Additional distance allowances for the predetermined turn endpoint may be required due to environmental conditions (current, tide, etc.) and operational considerations.

Note that, for the tail or rearmost streamer vessel in a fleet, e.g., vessel 502 in FIG. 5(a), the test as to whether the source and streamers are contributing to full fold is made first, and it is not necessarily a requirement for this trailing vessel 502 to have shaken out its residual streamer shape from the turn when the survey line begins because, at that time, it is only the lead vessel's streamers, e.g., streamers associated with vessel 500, that will be inside the survey patch. That is, at the time of the beginning of a survey line, it is desirable that the head or lead vessel 500's streamers have minimal turn shape, but the shape of the tail vessel 502's streamers is not as significant until those streamers are inside the full-fold boundary. This flexibility enables a reduction in turn time during line changes. Taking this point further, there is also no requirement for the source-only vessels, e.g., vessels 508, 510 and 512, to be in their diagonal alignment at the start of a survey line either, but this may be desirable under certain circumstances.

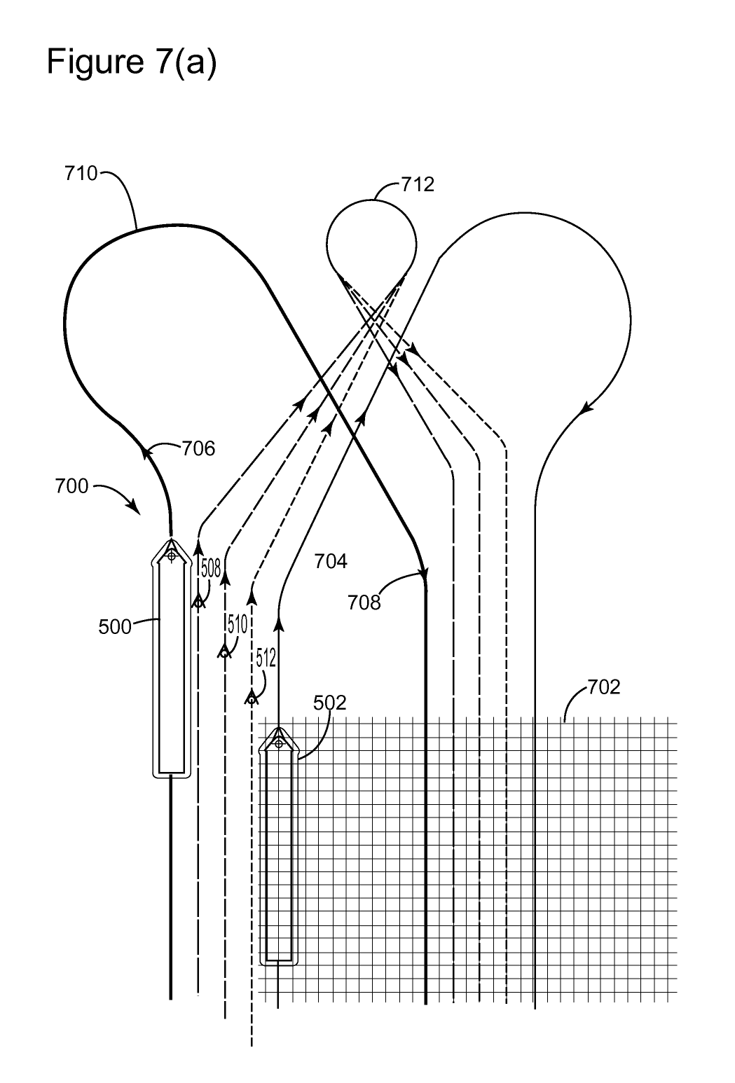

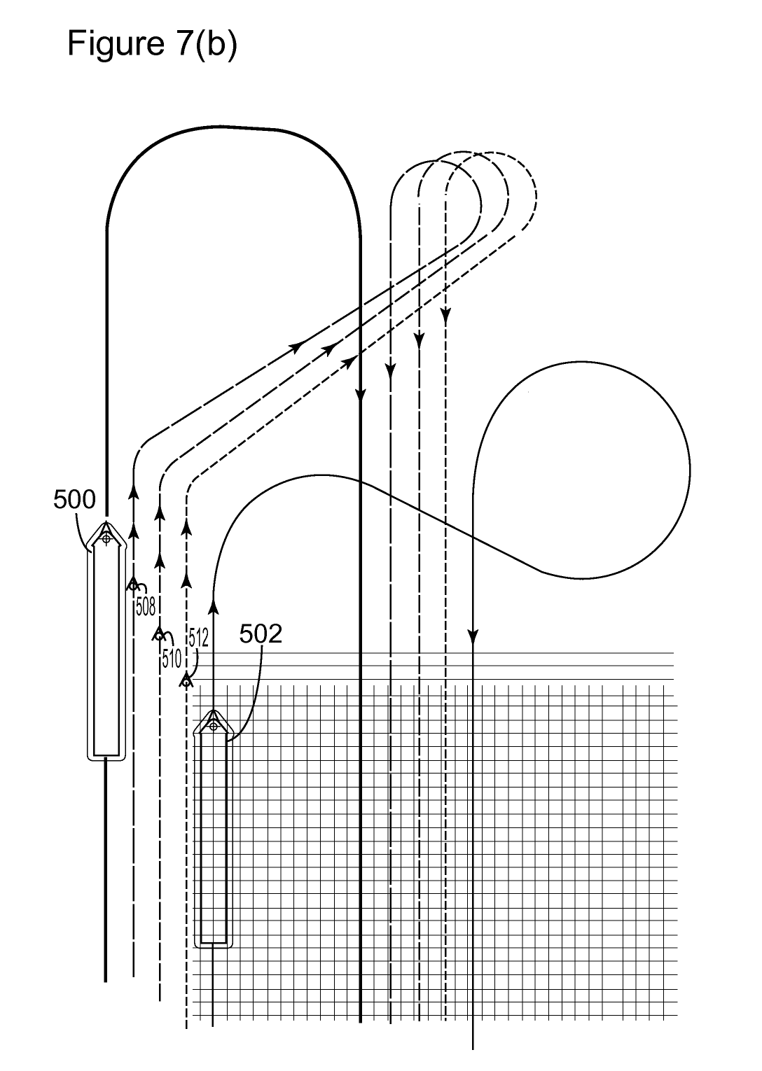

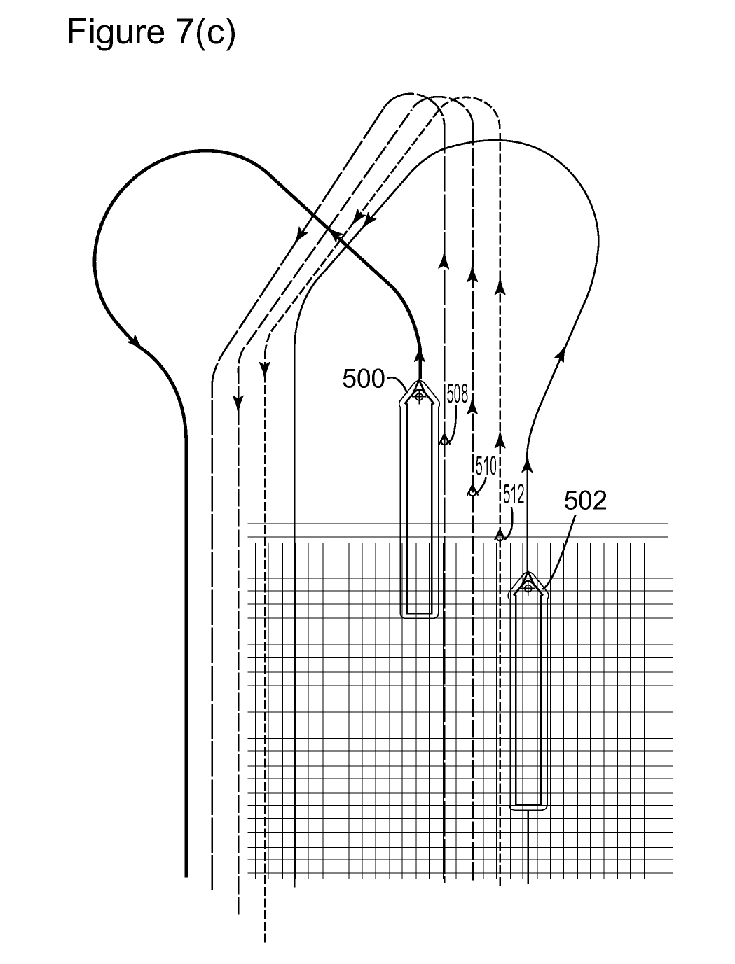

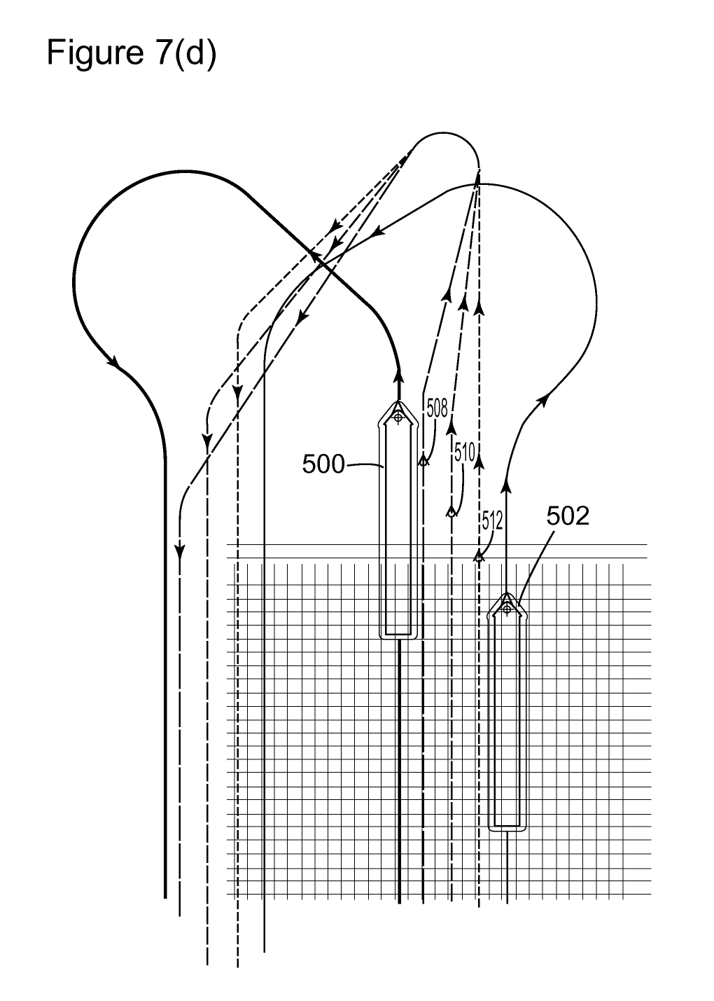

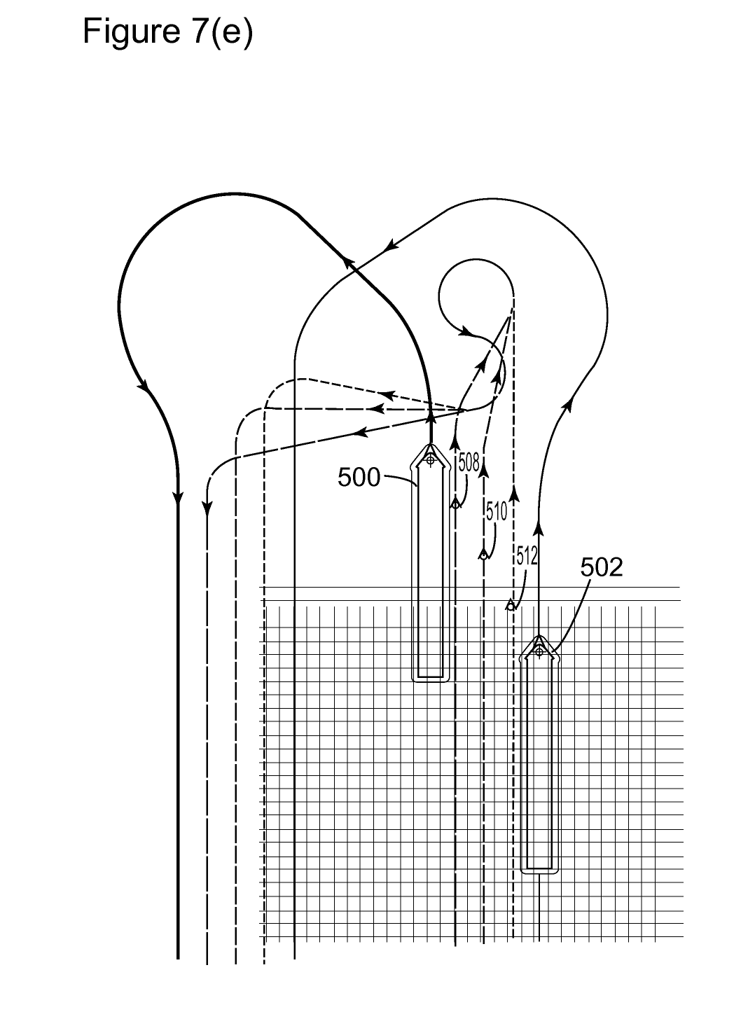

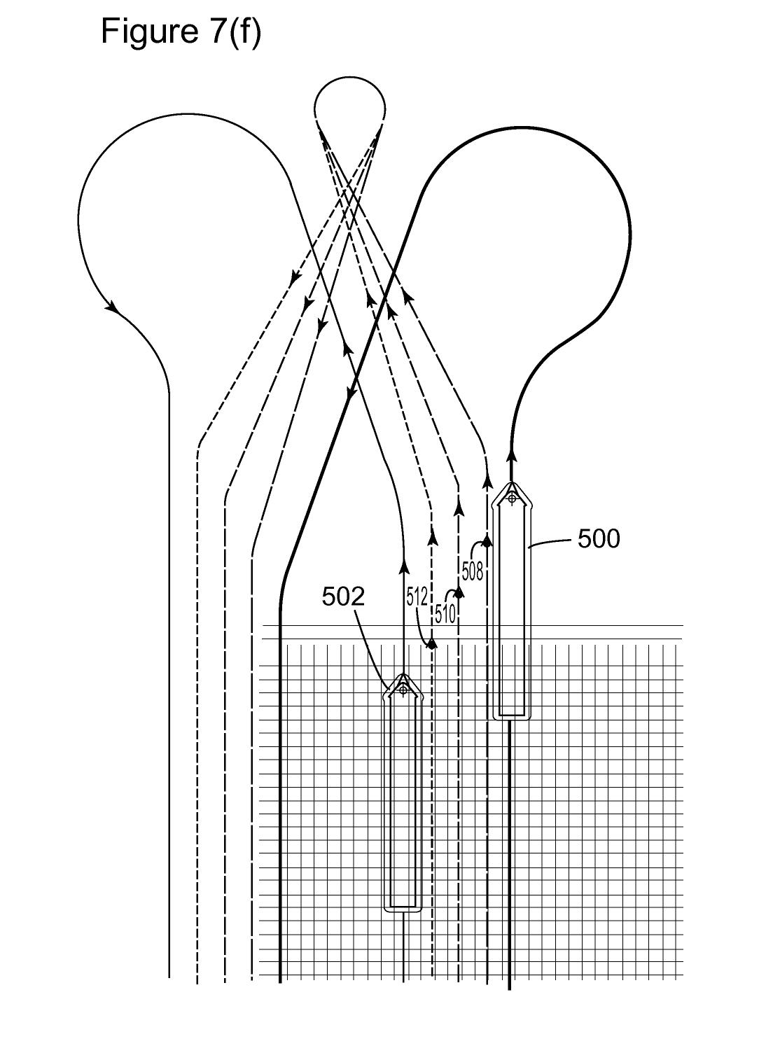

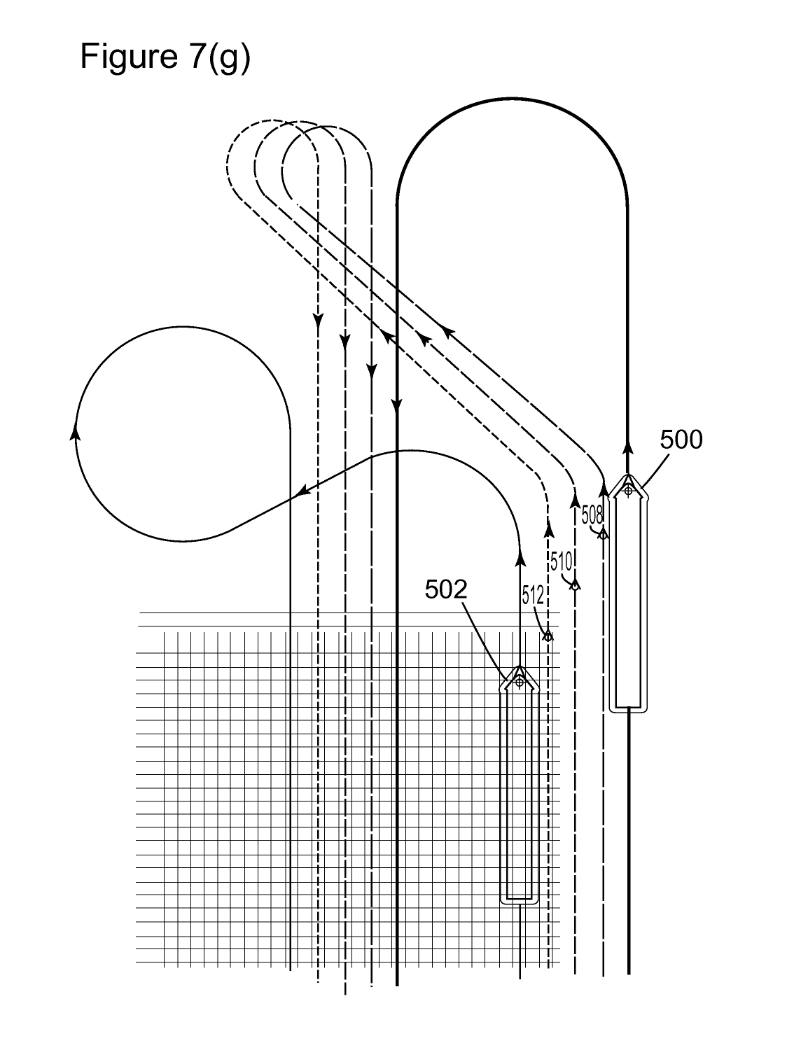

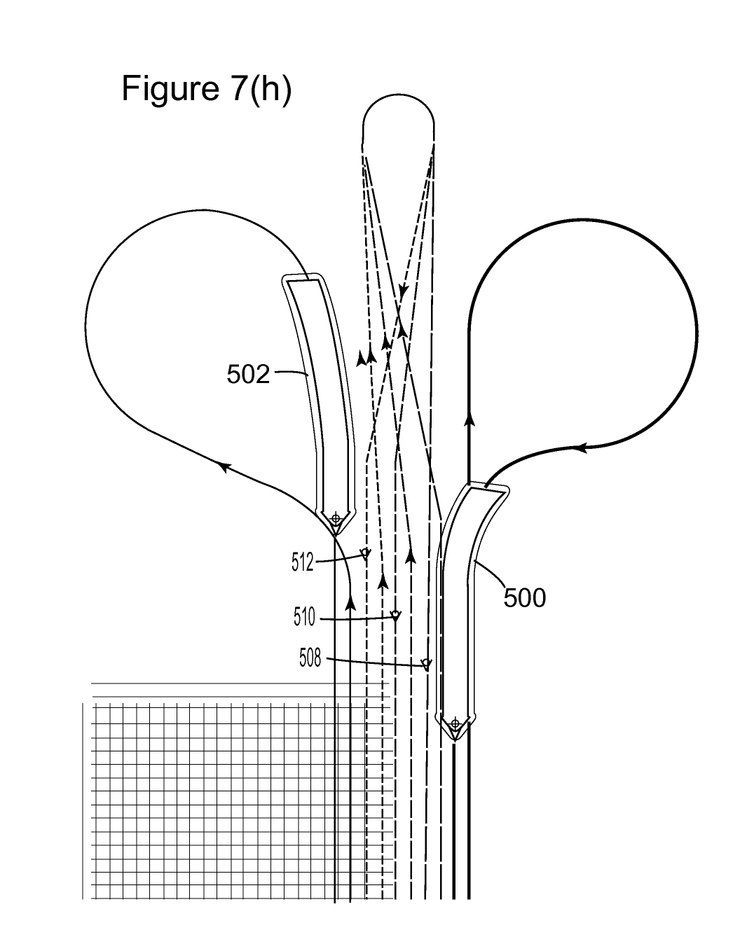

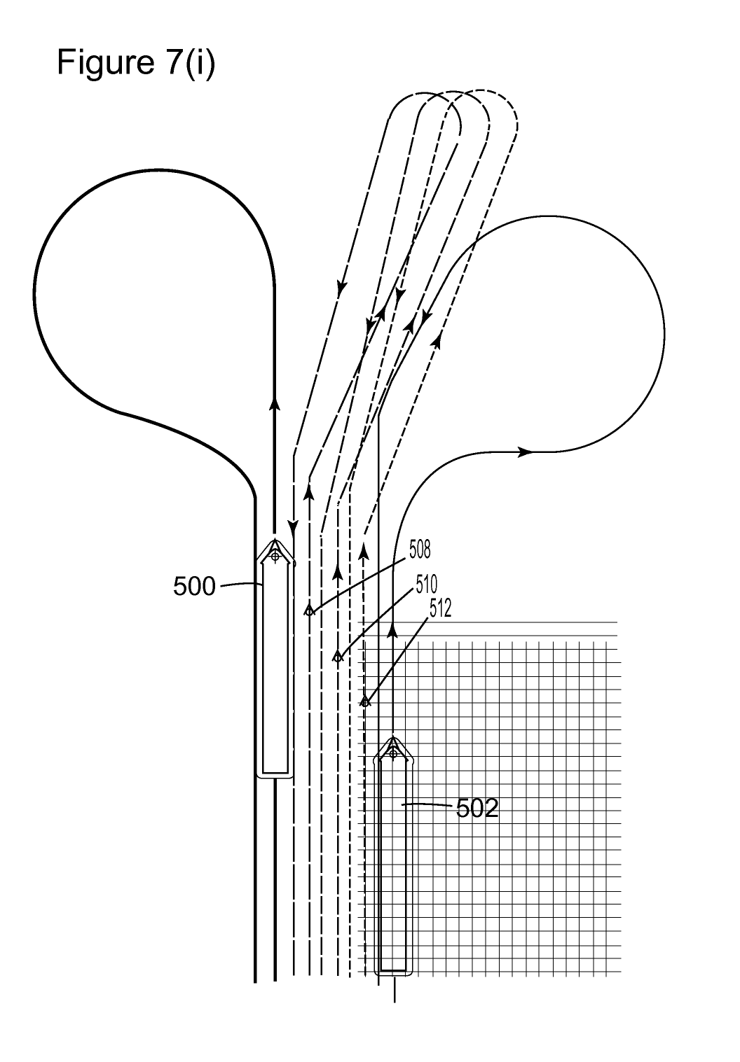

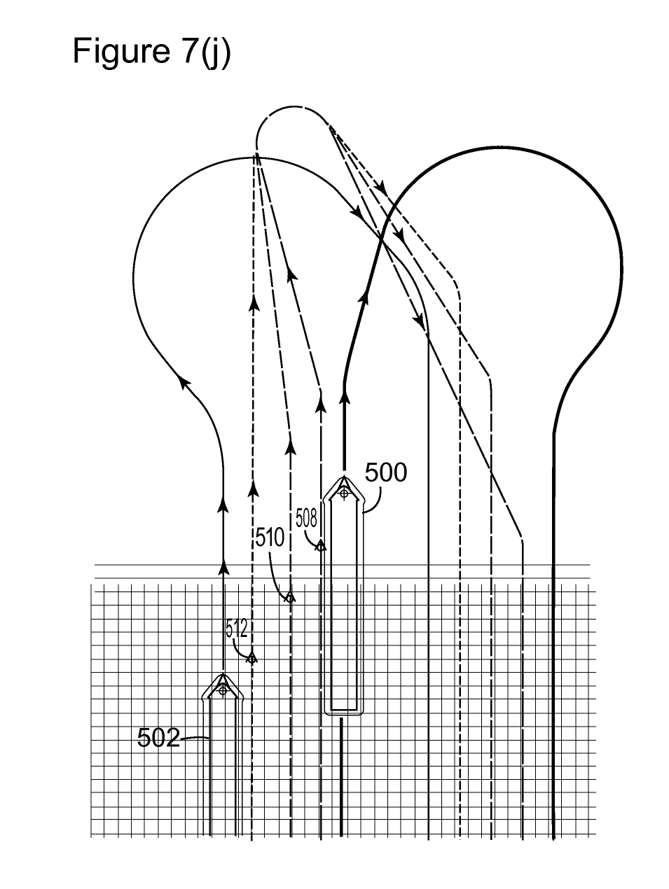

With the start and end points of the turn determined for each vessel, the remaining task is to construct a path for each vessel in the fleet during the turn that will keep all ships and their towed equipment clear of each other, based on the anticipated vessel speeds and predicted equipment positions under a variety of environmental conditions (current, tide, etc.). Many of the embodiments described below, and illustrated in FIGS. 7(a)-7(j) make use of the fact that vessels towing only a source, or set of sources arrays, can be moved closer together than their production positions and still be considered safe since the length of their towed equipment is typically less than that of vessels which tow streamer arrays. This, along with the built-in stagger 514 of the vessels in some of the fleet configurations considered in some of the embodiments enables the paths of the source vessels to converge, thereby providing a ‘follow-the-leader’ approach which creates extra space between those vessels and the adjacent vessels' towing cables. Among other things, turn patterns according to the embodiments will vary depending on various factors, described further below, including (but not limited to) the sense of the turn—port or starboard, the amount of crossline travel the fleet needs to make and whether the diagonal stagger is reversed or not. More specifically, the turn pattern or path generated between the predetermined start turn point and end turn point for each vessel can be a function of a number of different factors or constraints expressed as:

Turn Pattern(vessel N)=f(start point, end point, length, total distance, turn radius, anti-collision envelope, external effects) (1)

where:

start point=predetermined start point selected as described above,

end point=predetermined end point selected as described above,

length=the length of the equipment towed by vessel N

turn radius=radius of the turn for the particular vessel. As an example, a vessel towing streamers may describe a turn radius of around 4500-5000 m, whereas a vessel towing only a source may turn with radius of around 1500 m

total distance=total distance traversed by each vessel during its turn (preferably, but not limited to, a constant which is the same for all vessels in the fleet, at least for a given turn). As an example, the total turn length for any vessel might be of the order of 40,000 m in order to respect all other parameters in the function. Once this distance has been observed for one vessel, the turn lengths of the remaining vessels are set to be as close as possible to this, meaning they only need to observe the same average velocity to allow all vessels to end the turn at their designated points

anti-collision envelope=nominal locus around each vessel and the predicted extents of their towed equipment to ensure that separation (e.g., at least 500 m) is observed to prevent entanglement

external effects=an allowance or prediction of the effects that factors including, but not limited to, currents, tide, shoals, obstructions, and other shipping will have on the fleet's ability to turn.

As an illustration of the application of equation (1) to assist in the determination of the turn path, consider that, in the example provided as FIG. 7(a), the length of each vessels' path is approximately 40,000 meters from designated start to end points, the starting and ending diagonal stagger between each vessel was 1200 meters crossline and 330 m inline, all vessels were assumed to maintain a constant velocity of 4.5 knots, and a minimum anti-collision envelope of 500 m was to be observed after allowing for all anticipated external effects. In an iterative process of refinement, typically the turn patterns for the two streamer vessels were determined, then the turn paths for the three source vessels, and then minor adjustments were made to each in order to minimize the length of the turn.

Thus the vessels can then be turned along such paths as expressed by step 604 in FIG. 6. According to other embodiments, more, fewer or other factors may also be considered in equation (1). Using these techniques, a set of turn patterns or templates can be generated to cover the majority of survey scenarios, an exemplary set of which will now be described with respect to FIGS. 7(a)-7(j).

The afore-described turn pattern generating techniques will be better understood by the illustrative examples of FIGS. 7(a)-7(j). However those skilled in the art will appreciate that other turn patterns are contemplated by these embodiments. Moreover, these exemplary turn patterns are presented for the exemplary fleet of seismic survey vessels shown in FIG. 5(a) and described above, however these techniques can be used to generate patterns for other configurations, e.g., having more or fewer vessels, different vessel spacings, different towed equipment, etc.

Starting with FIG. 7(a), a seismic surveying fleet 700 includes the five vessels 500, 502, 508, 510 and 512 described above, including two vessels (500 and 502) including a source and towing an array of at least one streamer (not shown) and three vessels 506, 508 and 512 which are source only vessels. The fleet 700 is arranged in a long-offset, diagonally-staggered configuration as described above with respect to FIG. 5(a), and is performing a seismic survey in the manner described above with respect to a survey area which is partially illustrated in FIG. 7(a) by the illustrated grid and bounded in part by line 702. The remaining area shown in FIG. 7(a), outside of but also including the survey area 702 is referred to as geographical area 704. The turns of each vessel are performed in the geographical area 704 according to a predetermined turn path which is illustrated for each vessel as will now be described.

The fleet 700 is illustrated at a point in time and space where it is about to complete one survey pass or line in the survey area 702, turn around by 180 degrees, and commence a next survey pass or line in the survey area 702. A predetermined turn start point, turn end point and turn path are illustrated for each vessel 500, 502, 508, 510 and 512 in FIG. 7(a) according to this embodiment, which elements have been determined using the afore-described techniques. For example, source and streamer vessel 500 has a predetermined turn start point depicted by arrow 706, which can, for example, be determined as described above with respect to FIG. 6, step 600, such that the seismic wave energy of the source on the lead vessel 500 is no longer contributing to the received acoustic waves in the survey area 702.

Similarly, a predetermined turn end point depicted by arrow 708 in FIG. 7(a) can also be determined by, for example, the method step 602, e.g., for all source-only vessels in the fleet (such as vessels 508, 510 and 512), these vessels should be sailing on the survey line heading before their source contributes to any inline mid-points inside the survey boundary (i.e., full-fold area), that is before seismic waves generated by that source contribute detectable received wave energy at the inline midpoints. For the vessels in the fleet which have a source and are towing streamers (such as vessels 500 and 502), the predetermined end turn point can be determined to be at a position which ensures that that vessel's source is in the line heading before it contributes to any inline mid-points in the survey area and that the vessel's streamer cables are disposed substantially parallel to a direction of the next survey line, i.e., that any residual shape imparted to the streamers from the turning process is removed. The turn path, illustrated by the line 710 between points 706 and 708, can be determined as set forth above with respect to step 604 and based on the considerations described below. Similar start points, end points and turn paths are shown for each of the other vessels 502, 508, 510 and 512.

The fleet turn pattern of the embodiment of FIG. 7(a) has certain noteworthy characteristics. First, the turn paths of the source-only vessels 508, 510 and 512 substantially converge for most of their 360 degree turn radius as shown by the substantial overlap of their respective turn paths in the “circle” 712. This “follow-the-leader” approach to generating the turn pattern of FIG. 7(a) is enabled, at least in part, by the diagonally-staggered aspect of the configuration of fleet 700 such that the vessels 508, 510 and 512 are able to traverse a substantially similar turn path without colliding or entangling their towed equipment. Benefits of such a turn pattern for the source-only vessels include, for example, pattern simplicity (making it easier to maintain a desired inline separation between the source-only vessels), safety with respect to the turn paths of the source/streamer vessels (i.e., by taking up less of the geographical area 704 for the turn paths of the source-only vessels, more clearance with respect to the turn paths of the source/streamer vessels is gained). By way of contrast, it can be seen in FIG. 7(a) that the turn path 710 of the source/streamer vessel 500 and the turn path of the other source/streamer vessel only cross at one point.

FIG. 7(a) may, for example, provide an appropriate turn pattern to follow when the fleet is sailing North, and has a diagonal offset with the leftmost ship leading and the right most ship lagging, and needs to move to a new sail line to the East, to be acquired heading South with a diagonal orientation from SW to NE. As another example, it may be desirable to follow this pattern when the current is light or in a Easterly direction but less so during stronger Northerly or Westerly currents when the proximity of streamers towed by vessel 502 to the source vessels 508, 510 and 512 after completion of part 712 may be a concern.

FIGS. 7(b)-7(j) show alternate embodiments of turn patterns for fleet 700 which may be employed by the fleet to turn from one survey line to another based on varying considerations such as environmental conditions, turn sense, cross line turn distance, etc. For example, FIG. 7(b) may be an appropriate turn pattern to follow when the fleet is sailing North with a diagonal offset configuration with the leftmost ship leading and the right most ship lagging, and needs to move to a new sail line to the East, to be acquired heading South with a diagonal orientation from SW to NE. This makes it similar to FIG. 7(a) however this pattern may be more desirable if stronger Westerly or Northerly currents are anticipated because there is increased separation between the streamers towed by streamer vessels 500 and 502 and the source vessels 508, 510 and 512. This pattern is also desirable if vessel 500 wishes to have more linear segments in the turn and fewer arcs, e.g. for maintenance.

Other turning patterns which can be generated using the afore-described techniques are shown in FIGS. 7(c) and 7(d). These may be appropriate turn patterns to follow when, for example, the fleet is sailing North with a diagonal orientation from NW to SE and needs to move to a new sail line to the West, to be acquired heading South with a diagonal orientation from SW to NE. FIG. 7(c) keeps the source vessels 508, 510 and 512 contained between the paths of the two streamer vessels 500 and 502 which may improve confidence in avoiding a collision between source vessels' equipment and trailing vessel 502. FIG. 7(d) forgoes this, instead placing source vessel 508 on one side of streamer vessel 502's track, source vessel 510 substantially on streamer vessel 502's track and source vessel 512 on the other side of streamer vessel 502's track, but has the advantage of the source vessels earlier counter-clockwise arcs being superimposed instead of partially overlapped as in FIG. 7(c)

FIG. 7(e) may be an appropriate turn pattern to follow when the fleet is sailing North with a diagonal orientation from NW to SE and needs to move to a new sail line to the West, to be acquired heading South with a diagonal orientation from SW to NE. This pattern takes the benefits of the turn patterns of FIGS. 7(c) and 7(d); i.e., superimposed turn circles for the source-only vessels 508, 510 and 512 as well as keeping the same source vessels enclosed between the two streamer sets in the latter part of the turn. However this turn may be less appropriate when strong Northerly currents are encountered due to the potential proximity of source vessels to the streamer set at the northern-most part of the turn.

FIG. 7(f) may be an appropriate turn pattern to follow when the fleet is sailing South with a diagonal orientation from SW to NE and needs to move to a new sail line to the East, to be acquired heading North with a diagonal orientation from NW to SE. Sharing similar geometry to FIG. 7(a), this turn pattern may be less desirable during expected periods of strong southerly or westerly current.

FIG. 7(g) may be an appropriate turn pattern to follow when the fleet is sailing South with a diagonal orientation from SW to NE and needs to move to a new sail line to the East, to be acquired heading North with a diagonal orientation from NW to SE. Sharing similar geometry to FIG. 7(b), this turn pattern may be more desirable if stronger Westerly or Southerly currents are anticipated because there is increased separation between the streamers towed by streamer vessel 502 and source vessels 508, 510 and 512. This pattern is also desirable if streamer vessel 500 wishes to have more linear segments in the turn and fewer arcs, e.g. for maintenance.

FIGS. 7(h) and 7(i) illustrate specialized turn patterns which, according to embodiments, can be employed for occasions when the fleet needs to traverse only a short distance crossline. For example, FIG. 7(h) may be an appropriate turn pattern to follow when the fleet is sailing South with a diagonal orientation from SW to NE and needs to move to a new sail line to the East, to be acquired heading North with a diagonal orientation from NW to SE. Alternatively, FIG. 7(i) may be an appropriate turn pattern to follow when the fleet sailing North with a diagonal orientation from NW to SE needs to move to a new sail line to the West, to be acquired heading South with a diagonal orientation from SW to NE.

FIG. 7(j) may be appropriate turn patterns to follow when the fleet sailing South with a diagonal orientation from SW to NE needs to move to a new sail line to the West, to be acquired heading North with a diagonal orientation from NW to SE.

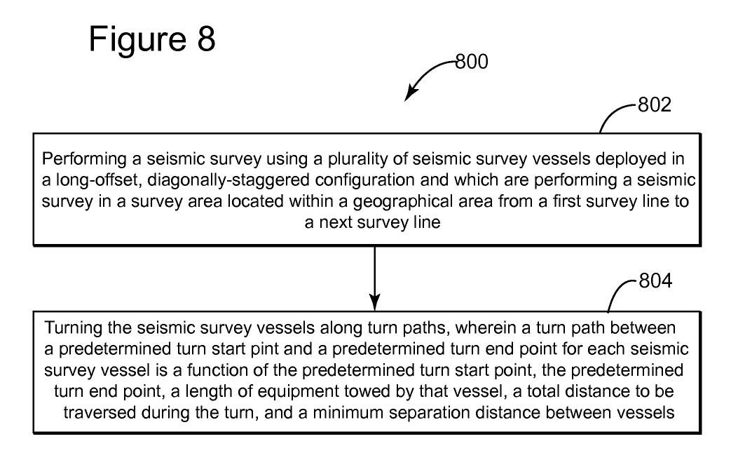

It will be appreciated from the foregoing discussions, that embodiments contemplate, among other things, methods for performing seismic surveys which are more general than those discussed above with respect to, e.g., FIG. 6. For example, as shown in FIG. 8, a method 800 for performing seismic surveys can include the steps of performing 802 a seismic survey using a plurality of seismic survey vessels deployed in a long-offset, diagonally-staggered configuration and which are performing a seismic survey in a survey area located within a geographical area from a first survey line to a next survey line, and turning 804 the seismic survey vessels along turn paths, wherein a turn path between a predetermined turn start point and a predetermined turn end point for each seismic survey vessel is a function of the predetermined turn start point, the predetermined turn end point, a length of equipment towed by that vessel, a total distance to be traversed during the turn, and a minimum separation distance between vessels.

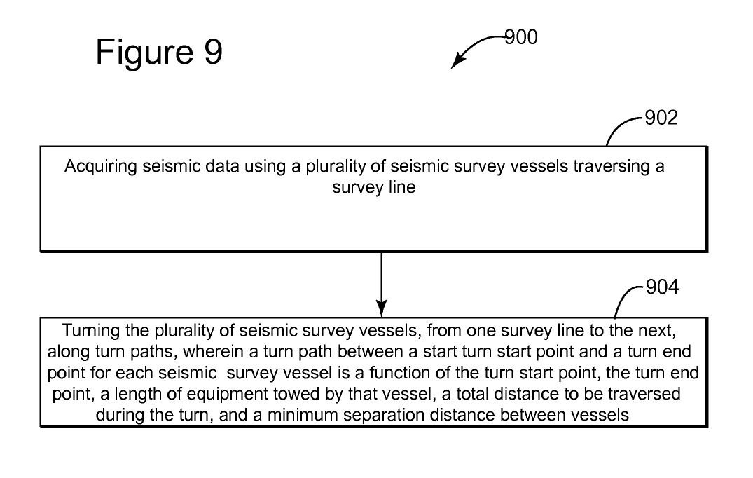

Another such example is provided in FIG. 9, wherein a method 900 for performing seismic surveys can include the steps of acquiring 902 seismic data using a plurality of seismic survey vessels traversing a survey line; and turning 904 the plurality of seismic survey vessels, from one survey line to the next, along turn paths, wherein a turn path between a start turn start point and a turn end point for each seismic survey vessel is a function of the turn start point, the turn end point, a length of equipment towed by that vessel, a total distance to be traversed during the turn, and a minimum separation distance between vessels. Those skilled in the art will appreciate that other formulations of the concepts and parameters for performing seismic surveys, and more specifically for turning seismic survey vessels in a long offset, diagonally staggered formation, can be expressed as well and that such other formulations are also intended to be further embodiments.

Additionally, although expressed as methods, each of the methods of, e.g., FIGS. 6, 8 and 9, can also be implemented as systems or means for performing the claimed method steps as will be appreciated by those skilled in the art. For example, navigation systems onboard the seismic survey vessels, in conjunction with GPS technology, can be programmed or otherwise controlled to perform the methods set forth herein. Such systems can include computers or processors which are programmed to implement survey paths, including the turning methodologies, described here.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

1. A seismic surveying method comprising:
turning a fleet of seismic surveying vessels having a long-offset, diagonally-staggered configuration and which are performing a seismic survey in a survey area located within a geographical area from a first survey line to a next survey line, the fleet including source-only seismic surveying vessels and streamer towing surveying vessels by:
beginning to turn each seismic surveying vessel in the fleet away from the first survey line at its predetermined turn start point,
wherein the predetermined turn start point for a respective vessel is disposed at a point in the geographical area such that an inline mid-point (M) between the respective vessel's source and a most distant receiver or set of receivers in the fleet is no longer within the survey area;
ending the turn of each seismic surveying vessel in the fleet into the next survey line at its predetermined turn end point,
wherein the predetermined turn end point is disposed at a point in the geographical area such that for all source-only seismic surveying vessels in the fleet, these source-only vessels are positioned on a heading of the next survey line before their respective source contributes seismic wave energy to points inside the survey area, and such that for streamer towing seismic surveying vessels the vessel's streamer cables are disposed substantially parallel to a direction of the next survey line, and
navigating the seismic survey vessels along turn paths, wherein a turn path between the predetermined turn start point and predetermined turn end point for each seismic surveying vessel in the fleet is a function of the predetermined turn start point, the predetermined turn end point, a length of equipment towed by that vessel, a total distance to be traversed during the turn, and a minimum separation distance between vessels.

2. The method of claim 1, wherein the fleet of seismic surveying vessels having the long-offset, diagonally-staggered configuration further comprises:
a first seismic surveying vessel having a source and a towed array of at least one streamer;
at least one source-only seismic surveying vessel having a towed array of sources; and
a second seismic surveying vessel having a source and a towed array of at least one streamer,
wherein the first seismic surveying vessel, the at least one source-only seismic surveying vessel and the second seismic surveying vessel are offset relative to one another by an inline distance of at least 300 m.

3. The method of claim 2, wherein the inline distance is at least 1 km.

4. The method of claim 2, wherein the inline distance is at least 2 km.

5. The method of claim 2, wherein the at least one source-only seismic surveying vessel is three source-only seismic surveying vessels.

6. The method of claim 5, wherein the turn path for each of the three source-only seismic surveying vessels substantially converge during a portion of the turn path where the source-only seismic vessels are turning around.

7. A seismic survey method comprising:
performing a seismic survey using a plurality of seismic survey vessels deployed in a long-offset, diagonally-staggered configuration and which are performing a seismic survey in a survey area located within a geographical area from a first survey line to a next survey line, and
turning the seismic survey vessels along turn paths, wherein a turn path between a predetermined turn start point and a predetermined turn end point for each seismic survey vessel is a function of the predetermined turn start point, the predetermined turn end point, a length of equipment towed by that vessel, a total distance to be traversed during the turn, and a minimum separation distance between vessels.

8. The method of claim 7, wherein the plurality of seismic survey vessels deployed in the long-offset, diagonally-staggered configuration further comprises:
a first seismic survey vessel having a source and a towed array of at least one streamer;
at least one source-only seismic survey vessel having a towed array of sources; and
a second seismic survey vessel having a source and a towed array of at least one streamer,
wherein the first seismic surveying vessel, the at least one source-only seismic surveying vessel and the second seismic surveying vessel are offset relative to one another by an inline distance of at least 300 m.

9. The method of claim 8, wherein the inline distance is at least 1 km.

10. The method of claim 8, wherein the inline distance is at least 2 km.

11. The method of claim 8, wherein the at least one source-only seismic survey vessel is three source-only seismic surveying vessels.

12. The method of claim 11, wherein the turn paths for the three source-only seismic surveying vessels substantially converge during a portion of the turn path where the source-only seismic vessels are turning around.

13. The method of claim 8, wherein each turn path is also a function of predicted external effects.

14. A method for performing seismic surveys comprising:
acquiring seismic data using a plurality of seismic survey vessels traversing a survey line; and
turning the plurality of seismic survey vessels, from one survey line to the next, along turn paths, wherein a turn path between a start turn start point and a turn end point for each seismic survey vessel is a function of the turn start point, the turn end point, a length of equipment towed by that vessel, a total distance to be traversed during the turn, and a minimum separation distance between vessels.

15. The method of claim 14, wherein the plurality of seismic survey vessels are deployed in a long-offset, diagonally-staggered configuration, which configuration further comprises:
a first seismic survey vessel having a source and a towed array of at least one streamer;
at least one source-only seismic survey vessel having a towed array of sources; and
a second seismic survey vessel having a source and a towed array of at least one streamer,
wherein the first seismic surveying vessel, the at least one source-only seismic surveying vessel and the second seismic surveying vessel are offset relative to one another by an inline distance of at least 300 m.

16. The method of claim 15, wherein the inline distance is at least 1 km.

17. The method of claim 15, wherein the inline distance is at least 2 km.

18. The method of claim 15, wherein the at least one source-only seismic survey vessel is three source-only seismic surveying vessels.

19. The method of claim 18, wherein the turn paths for the three source-only seismic surveying vessels substantially converge during a portion of the turn path where the source-only seismic vessels are turning around.

20. The method of claim 14, wherein each turn path is also a function of predicted external effects.
